(19) United States
(12) Patent Application Publication
(10) Pub. No.: US 2015/0180158 A1
(43) Pub. Date: Jun. 25, 2015

(54) WATERPROOF CONNECTOR

(71) Applicant: Japan Aviation Electronics Industry, Limited, Tokyo (JP)

(72) Inventors: Katsumi Arai, Tokyo (JP); Hiroshi Akimoto, Tokyo (JP); Masayuki Nishikata, Tokyo (JP)

(21) Appl. No.: 14/401,077

(22) PCT Filed: Feb. 21, 2013
(86) PCT No.: PCT/JP2013/054287

§ 371 Date: Nov. 13, 2014

(30) Foreign Application Priority Data
May 17, 2012 (JP) 2012-113433

(51) Int. Cl. H01R 13/52

(52) U.S. Cl. CPC H01R 13/521

(57) ABSTRACT

A waterproof connector, provided with: a housing (11); at least one contact (12) fixed to the housing (11), each contact (12) having a contacting part (12a) which is formed at one end and which comes into contact with the contact of the counterpart connector, a substrate attachment part (12d) formed at the other end and attached to the substrate, a housing fixing part (12b) formed between the contacting part (12a) and the substrate attachment part (12d), and an elastic member attachment part (12c) formed between the housing fixing part (12b) and the substrate attachment part (12d); and a waterproofing elastic member (13) attached to the elastic member attachment part (12c) of the contact (12). The housing (11) has at least one through-hole (16) into which the contact (12) is inserted, and a concave elastic member containing part (15) communicating with the through-hole (16). The housing fixing part (12b) of the contact (12) is pressed into and fixed in the corresponding through-hole (16) of the housing (11), and the elastic member (13) is contained in the elastic member containing part (15) of the housing (11).

### TECHNICAL FIELD

The present invention relates to a waterproof connector, in particular, to a waterproof connector which uses an elastic member for waterproofing and is to be mounted on a board.

### BACKGROUND ART

Recently, there is a strong demand for the improved waterproof function in various electronic devices, and accordingly developments of waterproof connectors have been promoted

In an exemplary waterproof connector, a contact is attached so as to penetrate through a housing, and a contact portion of the contact exposed to the outside of the housing is brought into contact with another contact of a counter connector. In the waterproof connector of this type, a penetration part in which the contact penetrates has to be sealed to secure a waterproof function.

For example, Patent Literature 1 discloses a waterproof connector in which a contact 1 penetrates through a housing 2, and a peripheral region of the penetration part of the contact 1 is sealed with an elastic sealing member 3 as illustrated in FIG. 25.

The contact 1 is pressed into a through-hole 4 formed in the housing 2 and fixed to the housing 2, and a contact portion 5 of the contact 1 exposed to the outside of the housing 2 comes into contact with a contact 6 of a counter connector, thereby establishing electrical connection with the counter connector. An end portion of the contact 1 projecting inside the housing 2 is attached to a board or the like disposed in the housing 2.

The elastic sealing member 3 is pressed into an elastic-sealing-member accommodation portion 7 that is formed in the housing 2 and communicates with the through-hole 4 so as to prevent water from intruding into the housing 2 through a gap between the contact 1 and an inner wall of the through-hole 4.

### CITATION LIST

### Patent Literature

Patent Literature 1: JP 2008-176936 A

### SUMMARY OF INVENTION

### Technical Problems

In the connector disclosed in Patent Literature 1, the contact 1 is fixed at a part of the housing 2 where the contact 1 is pressed into the through-hole 4 of the housing 2 as described above, and in order to achieve a waterproof function, the elastic sealing member 3 is disposed outside of the housing 2, while the contact portion 5 of the contact 1 is disposed further outside the elastic sealing member 3. Accordingly, the distance from the part of the housing 2 where the contact 1 is fixed to the contact. portion. 5 of the contact 1 becomes inevitably long, and the contact portion 5 is thus likely to become shaky.

If the contact portion 5 of the contact 1 shakes and the position of the contact portion 5 does not stabilize, smooth fitting as well as reliable electrical connection with the counter connector may become difficult.

The present invention has been made in order to solve the problem described above and an object of the present invention is to provide a waterproof connector capable of smooth fitting as well as reliable electrical connection with a counter connector while fulfilling a waterproof function.

### Solution to Problems

A waterproof connector according to the present invention comprises: a housing; at least one contact held by the housing, the contact including a contact portion formed at one end of the contact to come into contact with another contact of a counter-connector, a board attachment portion formed at another end of the contact to be attached to a board, a housing fixing portion formed between the contact portion and the board attachment portion and fixed to the housing; and an elastic-member attachment portion formed between the housing fixing portion and the board attachment portion, wherein the housing has at least one through-hole through which the contact is inserted, and an elastic-member accommodation portion which has a concave shape and communicates with the through-hole, and wherein the housing fixing portion of the contact is pressed into and fixed in the corresponding through-hole of the housing, and the elastic member is accommodated in the elastic-member accommodation portion of the housing.

Preferably, the elastic member is integrally molded with the elastic-member attachment portion of the contact. Otherwise, the elastic member may have at least one slit for attaching the elastic member to the elastic-member attachment portion of the contact and is attached to the elastic-member attachment portion of the contact laterally through the slit that is opened.

It is preferable that the elastic-member attachment portion of the contact has a roughened surface or the elastic member is adhered to the elastic-member attachment portion of the contact with an adhesive.

The elastic-member attachment portion of the contact may have a smaller cross section than cross sections of other portions of the contact adjacent to the elastic-member attachment portion.

The elastic-member attachment portion of the contact may have a bent portion, and the elastic member may be attached to the elastic-member attachment portion so as to surround the bent portion.

The elastic member may be singly attached to a plurality of the contacts.

It may be constructed that the contact is formed of a flat plate member, and the housing fixing portion of the contact has a press-fitting dimension in a width direction larger than a width of the through-hole of the housing. In this case, the housing fixing portion of the contact is preferably provided with convexity and concavity on its side surfaces in a width direction.

It may also be constructed that The contact is formed of a flat plate member, and the housing fixing portion of the contact has a press-fitting dimension in a thickness direction larger than a height of the through-hole of the housing. In this case, the housing fixing portion of the contact is preferably formed to be thicker than other portions of the contact, and the press-fitting dimension is established by a thickness of the housing fixing portion. Otherwise, the flat plate member having a uniform thickness may be bent, thereby establishing the press-fitting dimension of the housing fixing portion of the contact.

Further, the housing preferably has at least one groove to accommodate the contact portion of the contact. The groove may have a sectional shape that covers both edge portions of the contact portion of the corresponding contact while allowing a center portion of a surface of the contact portion to be exposed.

It may be constructed that either one of the elastic-member accommodation portion of the housing and the elastic member is provided with a concave portion, whereas another one is provided with a convex portion corresponding to the concave portion, and the concave portion and the convex portion are fitted with each other. It may also be constructed that the elastic-member accommodation portion of the housing has an opening portion and an end portion formed to be wider than the opening portion, and the elastic member has a sectional shape corresponding to the elastic-member accommodation portion of the housing.

### ADVANTAGEOUS EFFECTS OF INVENTION

According to the present invention, a housing fixing portion is formed. between the contact portion and the board attachment portion, an elastic-member attachment portion is formed between the housing fixing portion and the board attachment portion, the housing fixing portion of the contact is pressed into and fixed in the through-hole of the housing, and an elastic member for waterproofing attached to the elastic-member attachment portion of the contact is accommodated in the elastic-member accommodation portion of the housing. Therefore, it is capable of smooth fitting as well as reliable electrical connection with a counter connector while fulfilling a waterproof function.

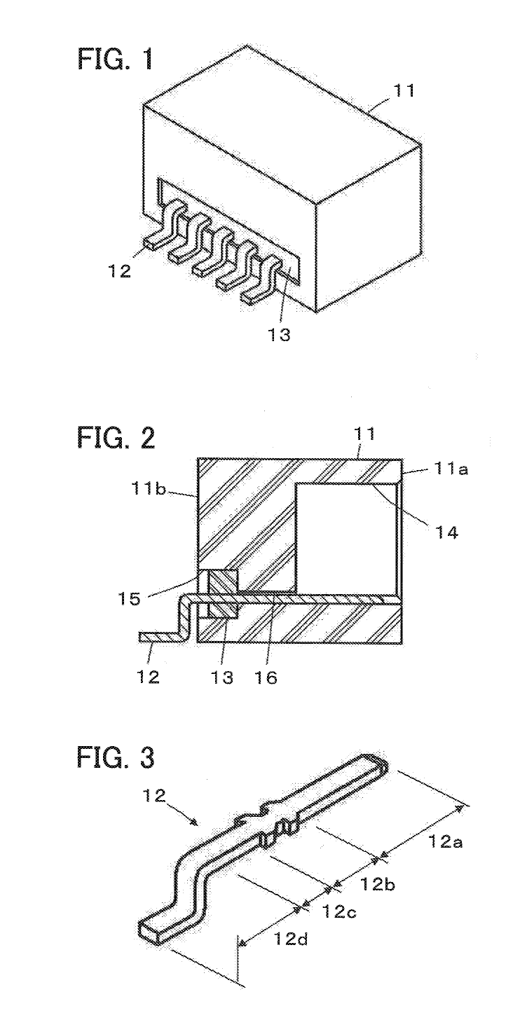

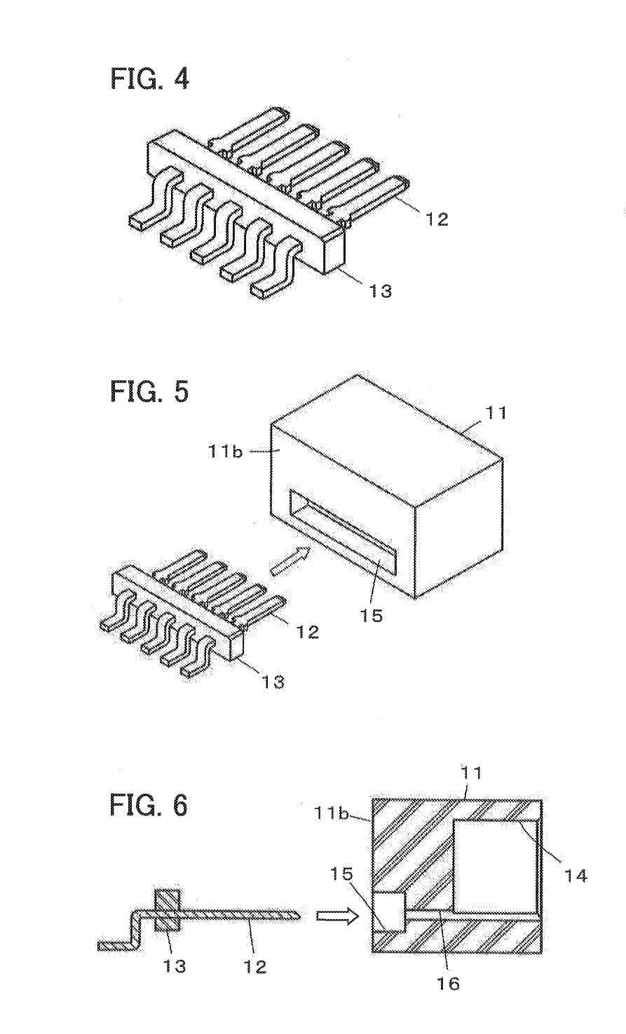

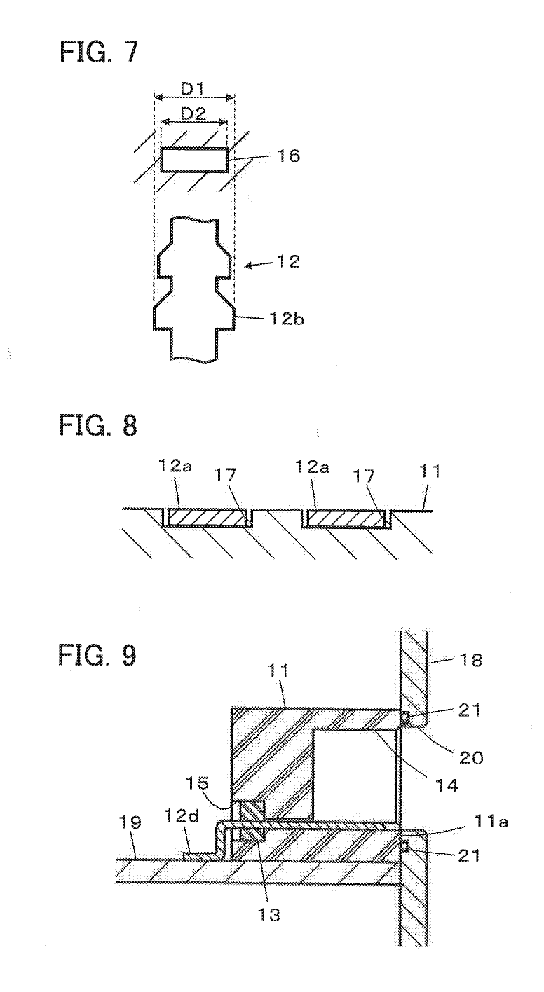

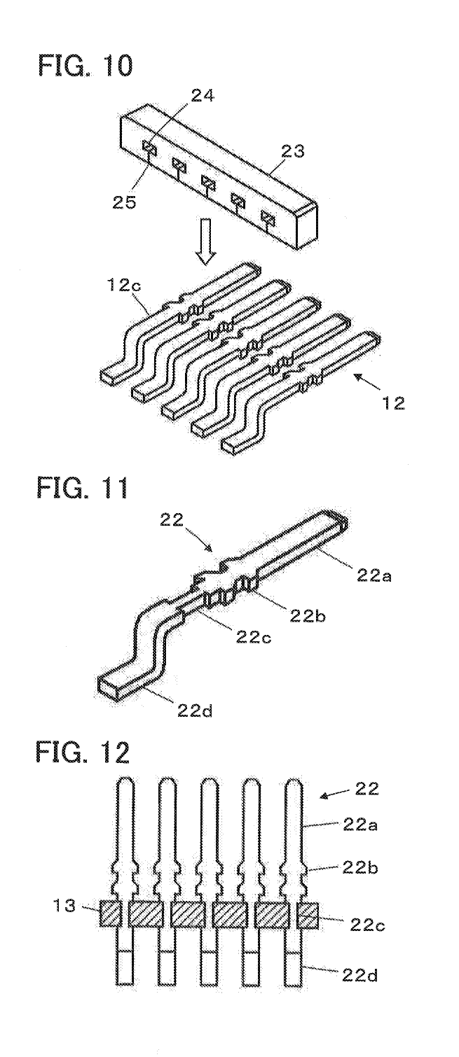

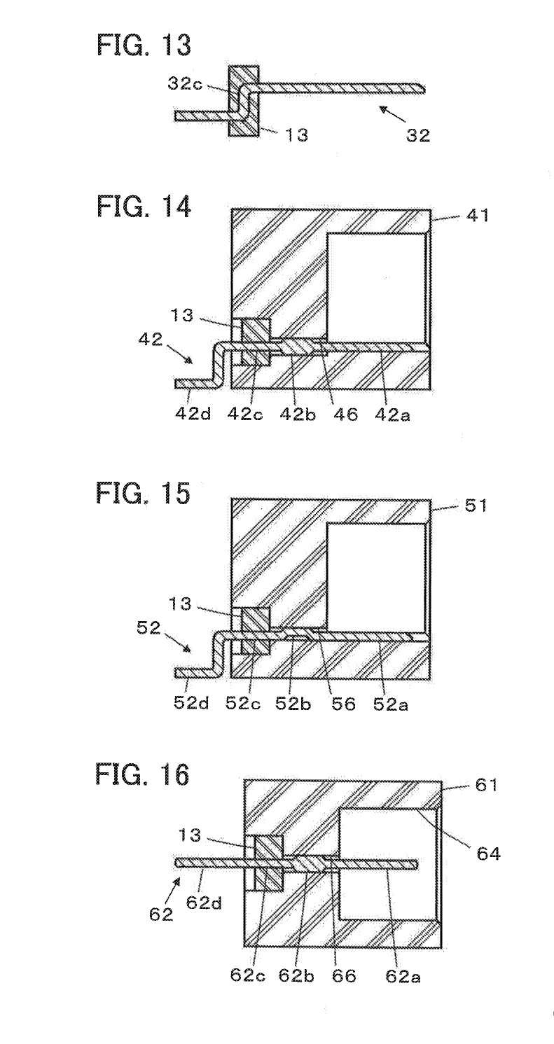

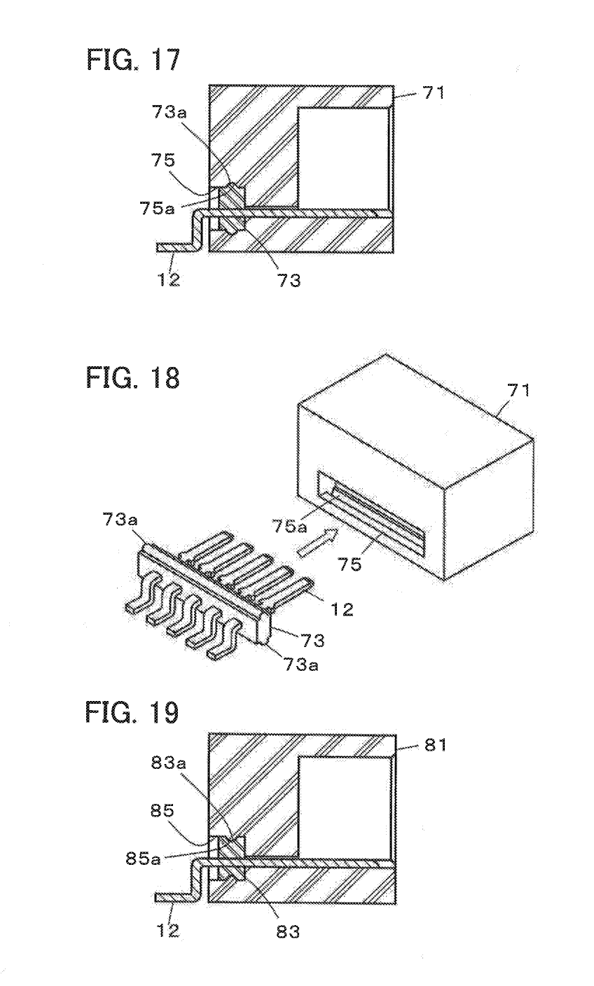

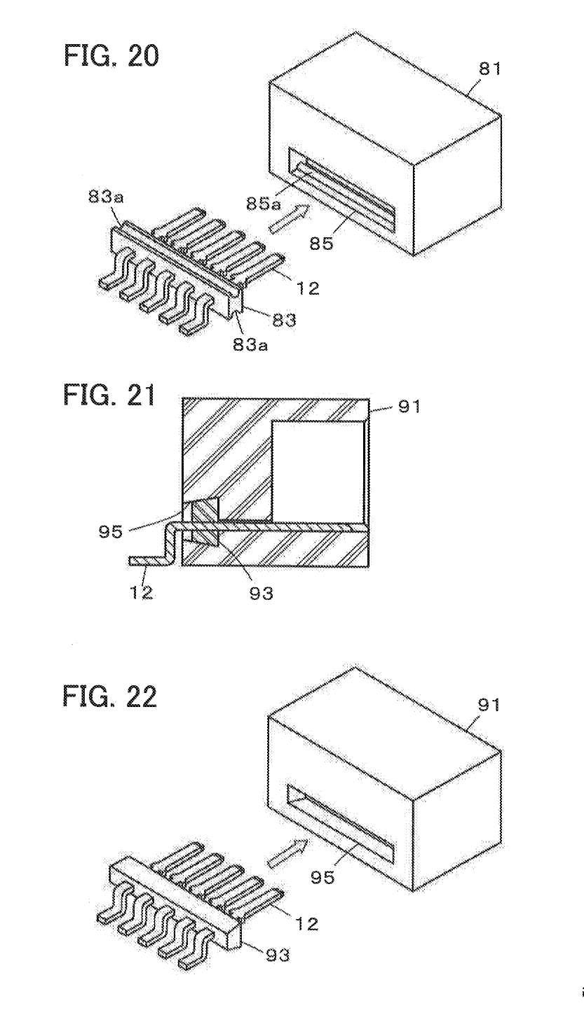

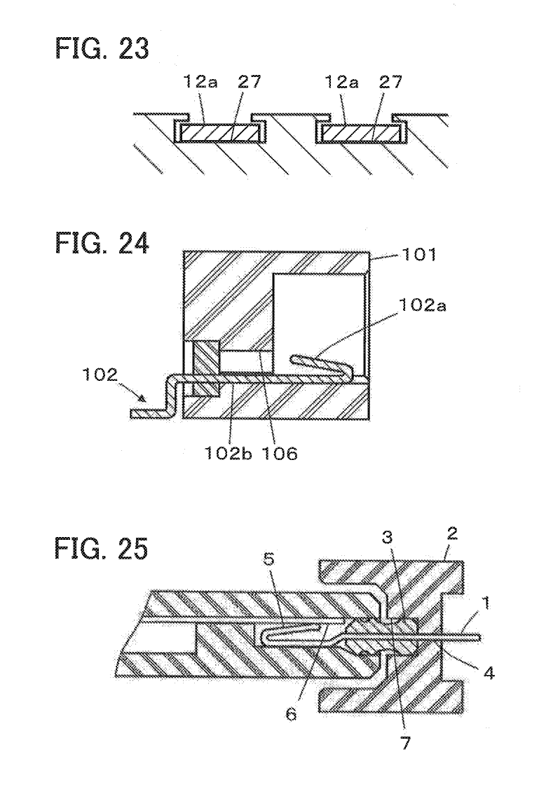

### BRIEF DESCRIPTION OF DRAWINGS

[FIG. 1] FIG. 1 is a perspective view of a waterproof connector according to Embodiment 1 of the present invention.

[FIG. 2] FIG. 2 is a cross-sectional view of the waterproof connector according to Embodiment 1.

[FIG. 3] FIG. 3 is a perspective view of a contact used in the waterproof connector according to Embodiment 1.

[FIG. 4] FIG. 4 is a perspective view illustrating the state in which a single elastic member is attached to a plurality of contacts.

[FIG. 5] FIG. 5 is a perspective view illustrating how to incorporate the contacts into a housing,

[FIG. 6] FIG. 6 is a cross-sectional view illustrating how to incorporate the contacts into the housing.

[FIG. 7] FIG. 7 is a diagram illustrating the relation between a housing fixing portion of the contact and a through-hole in the housing.

[FIG. 8] FIG. 8 is a cross-sectional view illustrating the state in which contact portions of the contacts are accommodated in grooves of the housing.

[FIG. 9] FIG. 9 is a cross-sectional view illustrating the state in which the waterproof connector according to Embodiment 1 is mounted on a board.

[FIG. 10] FIG. 10 is a perspective view of an elastic member and contacts used in a waterproof connector according to Embodiment 2.

[FIG. 11] FIG. 11 is a perspective view of a contact used in a waterproof connector according to Embodiment 3.

[FIG. 12] FIG. 12 is a cross-sectional view illustrating the state in which a single elastic member is attached to a plurality of contacts according to Embodiment 3.

[FIG. 13] FIG. 13 is a cross-sectional view illustrating a contact and an elastic member used in a waterproof connector according to a variation of Embodiment 3.

[FIG. 14] FIG. 14 is a cross-sectional view of a waterproof connector according to Embodiment 4.

[FIG. 15] FIG. 15 is a cross-sectional view of a waterproof connector according to a variation of Embodiment 4.

[FIG. 16] FIG. 16 is a cross-sectional view of a waterproof connector according to another variation of Embodiment 4.

[FIG. 17] FIG. 17 is a cross-sectional view of a waterproof connector according to Embodiment 5.

[FIG. 18] FIG. 18 is a perspective view illustrating how to incorporate contacts into a housing according to Embodiment 5.

[FIG. 19] FIG. 19 is a cross-sectional view of a waterproof connector according to a variation of Embodiment 5.

[FIG. 20] FIG. 20 is a perspective view illustrating how to incorporate contacts into a housing according to the variation of Embodiment 5.

[FIG. 21] FIG. 21 is a cross-sectional view of a waterproof connector according to another variation of Embodiment 5.

[FIG. 22] FIG, 22 is a perspective view illustrating how to incorporate contacts into a housing according to the other variation of Embodiment 5.

[FIG. 23] FIG. 23 is a cross-sectional view illustrating the state in which contact portions of contacts are accommodated in grooves of a housing according to another embodiment.

[FIG. 24] FIG. 24 is a cross-sectional view of a waterproof connector according to yet another embodiment.

[FIG. 25] FIG. 25 is a cross-sectional view of a structure of a conventional waterproof connector.

### DESCRIPTION OF EMBODIMENTS

Embodiments of the present invention will be described below based on the appended drawings.

### Embodiment 1

FIG. 1 illustrates a structure of a waterproof connector according to Embodiment 1 of the present invention. The waterproof connector includes a housing 11 having a cuboid outer shape and a plurality of contacts 12 fixed to the housing 11. A single common elastic member 13 for waterproofing is attached to the plurality of contacts 12, and the plurality of contacts 12 are attached to the housing 11 together with the elastic member 13.

As illustrated in FIG. 2, the housing 11 is provided with a counter-connector receiving portion 14 in a concave shape opening in a front face 11a of the housing 11 and an elastic-member accommodation portion 15 in a concave shape opening in a rear face 11b of the housing 11. The counter-connector receiving portion 14 is a space for receiving a counter connector which is to be fitted with the waterproof connector according to Embodiment 1, whereas the elastic-member accommodation portion 15 is a space for accommodating the elastic member 13 which is attached to the plurality of contacts 12 and is pressed into the elastic-member accommodation portion 15. The housing 11 is further provided with a plurality of through-holes 16 that correspond to the plurality of contacts 12 and connect the counter-connector receiving portion 14 with the elastic-member accommodation portion 15. The contacts 12 are inserted into the corresponding through-holes 16, respectively.

Each of the contacts 12 is formed of a flat plate member and is provided with a contact portion 12a to come into contact with a contact of the counter connector, a housing fixing portion 12b for fixing the contact 12 to the housing 11, an elastic-member attachment portion 12c to which the elastic member 13 is attached, and a board attachment portion 12d for attaching the contact. 12 to a board on which the waterproof connector is to be mounted, these portions being continuously formed at the contact 12 from its tip end to its rear end, as illustrated in FIG. 3. That is, the housing fixing portion 12b is located between the contact portion 12a formed at the tip end and the board attachment portion 12d formed at the rear end, and in addition the elastic-member attachment portion 12c is located between the housing fixing portion 12b and the board attachment portion 12d.

In addition, each of the contacts 12 has a uniform thickness over the whole length, and also has a uniform width in the contact portion 12a, the elastic-member attachment portion 12c and the board attachment portion 12d, except the housing fixing portion 12b. Each of the side surfaces of the housing fixing portion 12b is formed to have a concave-convex shape, and the housing fixing portion 12b has the maximum width that is larger than the width of other portions, i.e., the contact portion 12a, the elastic-member attachment portion 12c and the board attachment portion 12d.

Moreover, the contact portion 12a, the housing fixing portion 12b and the elastic-member attachment portion 12c are formed in a same plane so as to form a continuous flat plate. The board attachment portion 12d, on the other hand, has a bent shape for easy attachment to a board.

As illustrated in FIG. 4, the single elastic member 13 is attached to the plurality of contacts 12 each having the above-described shape. The elastic member 13 is integrally molded with the elastic-member attachment portions 12c of the plurality of contacts 12 through, for example, insert-molding. If the contact portion 12a to the elastic-member attachment portion 12c of each of the contacts 12 is inserted into an attachment hole formed in the elastic member in an attempt to fit the contacts 12 in the elastic member, the contact portion 12a may be damaged or contaminated by coming into contact with the elastic member. In this embodiment, however, since the elastic member 13 is integrally molded with the plurality of contacts 12, the contact portion 12a of each of the contacts 12 is free of contamination or damage, and reliable electrical connection with the contact of the counter connector can be ensured.

As illustrated in FIGS. 5 and 6, the plurality of contacts 12 with which the elastic member 13 is integrally molded are inserted from the contact portion 12a side into the housing 11 through the elastic-member accommodation portion 15 opening in the rear face 11b of the housing 11, whereby the waterproof connector is assembled.

In this process, the plurality of contacts 12 are respectively inserted into the corresponding through-holes 16 after passing through the elastic-member accommodation portion 15. The maximum width D1 of the housing fixing portion 12b of each of the contacts 12, i.e., the press fitting dimension in the width direction of the contact 12 is preliminarily set to be slightly larger than a width D2 of the through-hole 16 as illustrated in FIG. 7. Accordingly, during insertion of the contacts 12, at the time when the housing fixing portions 12b, following the contact portions 12a, reach the entrances of the through-holes 16 of the housing 11, a certain pressure is applied to press the contacts 12 into the housing 11, whereby the both side surfaces having the concave-convex shape of each of the housing fixing portions 12b bite into the inner wall of the corresponding through-hole 16. As a result, the housing fixing portions 12h are pressed into the through-holes 16.

When the housing fixing portions 12b are pressed in, the elastic member 13 integrally molded with the elastic-member attachment portions 12c of the plurality of contacts 12 is simultaneously accommodated in the elastic-member accommodation portion 15 of the housing 11. The elastic member 13 is preliminarily formed to have a larger width and a larger height than those of the elastic-member accommodation portion 15 of the housing 11. Therefore, by being pressed into the elastic-member accommodation portion 15, the elastic member 13 is accommodated in the elastic-member accommodation portion 15 in an elastically compressed state. Accordingly, a waterproof effect is imparted between the housing 11 and the contacts 12 in the elastic-member accommodation portion 15.

As described above, the waterproof connector in which the plurality of contacts 12 and the elastic member 13 are incorporated in the housing 11 is formed as illustrated in FIGS. 1 and 2.

The bottom part of the housing 11 inside the counter-connector receiving portion 14 is provided with a plurality of grooves 17 corresponding to the plurality of contacts 12 as illustrated in FIG. 8, and the contact portions 12a of the plurality of contacts 12 are respectively accommodated in the corresponding grooves 17. Hence, even if a stress is applied on the contact portion 12a of any of the contacts 12 in the direction toward an adjacent contact 12 due to some cause at the time of fitting with the counter connector or the like, the corresponding groove 17 restricts shifting of the contact portion 12a, thereby preventing defects such as a short-circuit between adjacent contacts 12.

The housing 11 can be formed of, for example, a resin material excellent in insulation property and formability, and the contacts 12 can be made of a metal material excellent in conductivity. The elastic member 13 can adopt, for example, a silicone rubber excellent in elasticity and waterproof property.

As exemplified in FIG. 9 the waterproof connector according to the embodiment is mounted on a board 19 attached within a casing 18 of an electronic device such as a mobile phone. The casing 18 is provided with an opening portion 20 corresponding to the counter-connector receiving portion 14 of the housing 11, and a gasket 21 is disposed on the periphery of the opening portion 20 to seal between an inner face of the casing 18 and the front face 11a of the housing 11.

The constitution described above can prevent moisture existing outside the casing 18 from intruding thereinto through the elastic-member accommodation portion 15 of the housing 11 owing to the elastic member 13 and also through a gap between the casing 18 and the housing 11 owing to the gasket 21, thereby achieving a waterproof function.

In Embodiment 1, the contacts 12 are fixed to the housing 11 by means of the housing fixing portions 12b being pressed into The corresponding through-holes 16. Since the housing fixing portion 12b is disposed adjacent to the contact portion 12a in each of the contacts 12 with a small distance, the contact portion 12a hardly shakes, stabilizing the position of the contact portion 12a with respect to the housing 11. Accordingly, the waterproof connector can be smoothly fitted with the counter connector and can establish reliable electrical connection therewith.

Here, FIGS. 1, 4 and 5 illustrate that five contacts 12 are attached to the housing 11. However, the number of the contacts 12 is not particularly limited to five but can be one to four or six or more.

In addition, instead of integrally molding the single elastic member 13 with all of the plurality of contacts 12, the elastic member may be separated into a plurality of pieces, and each of the pieces may be integrally molded with the corresponding contact 12. In this case, a plurality of elastic members may be accommodated in the single elastic-member accommodation portion 15 of the housing 11, or, alternatively, a plurality of elastic-member accommodation portions may be formed in the housing 11 to respectively accommodate the corresponding elastic members. One contact 12 and one elastic member 13 may be also integrally molded.

### Embodiment 2

In Embodiment 1 described above, the elastic member 13 is integrally molded with the elastic-member attachment portions 12c of the plurality of contacts 12. Meanwhile, as illustrated in FIG. 10, a plurality of attachment holes 24 corresponding to the plurality of contacts 12 can be formed in an elastic member 23, and a plurality of slits 25 respectively connected to the plurality of attachment holes 24 can be formed, whereby the slits 25 are elastically opened to allow the elastic-member attachment portions 12c of the corresponding contacts 12 to be inserted into the attachment holes 24. In other words, the elastic member 23 is attached to the elastic-member attachment portions 12c of the contacts 12 laterally through the slits 25 that are opened, not by means of insertion of the contacts 12 from the contact portions 12a through the elastic-member attachment portions 12c into the attachment holes 24 of the elastic member 23 to fit the contacts 12 into the elastic member 23.

As the elastic member 23 is pressed into the elastic-member accommodation portion 15 of the housing 11, the slits 25 are closed, causing the elastic member to firmly attach to the elastic-member attachment portions 12c of the contacts 12. A waterproof effect can be exercised in this manner.

The elastic member 23 having such constitution can be also used and can ensure reliable electrical connection with the contact of the counter connector without contamination or damage on the contact portions 12a of the contacts 12, like in the case of using the elastic member 13 according to Embodiment 1.

### Embodiment 3

FIG. 11 illustrates a structure of a contact 22 used in a waterproof connector according to Embodiment 3. Similarly to the contact 12 illustrated in FIG. 3, the contact 22 is formed of a flat plate member having a uniform thickness and is provided with a contact portion 22a, a housing fixing portion. 22b, an elastic-member attachment portion 22c and a board attachment portion 22d that are formed continuously at the contact 22 from its tip end to its rear end, while the elastic-member attachment portion 22c is formed to have a smaller width than widths of the contact portion 22a, the housing fixing portion 22b and the board attachment portion 22d. As illustrated in FIG. 12, an elastic member 13 is integrally molded with a plurality of elastic-member attachment portions 22c having a small width.

Since each of the elastic-member attachment portions 22c is formed to have a narrower width than that of any other portion, even if a stress is applied between the elastic member 13 and the contacts 12 in a direction to pull them out from each other, the elastic member 13 can be effectively prevented from coming off the contacts 22, thereby improving reliability of the waterproof connector.

As long as the elastic-member attachment portion 22c has a smaller cross section than those of other adjacent portions of each of the contacts 22, the elastic member 13 can be kept from coming off the contacts 22. Hence, also when the elastic-member attachment portion 22c is formed to have the same width as those of other portions but to be thinner than other portions, the same effect can be obtained. In addition, the elastic-member attachment portion. 22c can be formed to have both a smaller width and a thinner thickness than those of other portions.

Also in the case where, in place of an integrally molded elastic member 13, the elastic member 23 provided with the attachment holes 24 and the slits 25 as illustrated in FIG. 10 is attached to the elastic-member attachment portions 22c of the contacts 22, the elastic member 23 can be similarly prevented from coming off the contacts 22 in an effective manner, thereby improving reliability of the waterproof connector.

Further, if a bent portion is formed at an elastic-member attachment portion 32c like in a contact 32 illustrated in FIG. 13 and the elastic member 13 is integrally molded so as to surround the bent portion of the elastic-member attachment portion 32c, the elastic member 13 can be also prevented from coming off the contacts 32.

Moreover, by having a surface of the elastic-member attachment portion 12c of the contact 12 illustrated in FIG. 3 roughened as well as by using the elastic member 13 integrally molded with the elastic-member attachment portions 12c or attaching the elastic member 23 to the elastic-member attachment portions 12c, an effect of preventing the elastic member 13 or 23 from coming off the contacts 12 can be also obtained. The surface of the elastic-member attachment portion 22c of the contact 22 illustrated in FIG. 11 and the surface of the elastic-member attachment portion 32c of the contact 32 illustrated in FIG. 13 can be also roughened.

In the case where the elastic member 23 is attached to the contacts 12 or 22 by means of the slits 25, the elastic member 23 can be adhered to the elastic-member attachment portions 12c of the contacts 12 or to the elastic-member attachment portions 22c of the contacts 22 with an adhesive. Accordingly, the waterproofing property can be enhanced while the effect of preventing the elastic member 23 from coming off the contacts 12 or 22 can be efficiently achieved.

### Embodiment 4

In Embodiment 1 described above, since the housing fixing portion 12b of each of the contacts 12 has a press-fitting dimension in the width direction larger than the width of the through-hole 16, and both side surfaces having a concave-convex shape of the housing fixing tort ion 12h bite into the inner wall of the through-hole 16, the housing fixing portion 12b is pressed into and fixed in the through-hole 16. However, this is not the sole case, and even if the housing fixing portion of each of the contacts has a press-fitting dimension in the thickness direction larger than the height of the through-hole 16, the contact can be pressed into and fixed in the through-hole 16.

FIG. 14 illustrates a structure of a waterproof connector according to Embodiment 4. Similarly to the contact 12 illustrated in FIG. 3, a contact 42 used in the waterproof connector is formed of a flat plate member and is provided with a contact portion 42a, a housing fixing portion 42b, an elastic-member attachment portion 42c and a board attachment portion 42d that are formed at the contact 42 continuously from its tip end to its rear end. On the other hand, the housing fixing portion 42h has a larger thickness than thicknesses of the contact portion 42a, the elastic-member attachment portion 42c and the board attachment portion 42d, while the thickness of the housing fixing portion 42h constitutes the press-fitting dimension in the thickness direction.

The thickness of the housing fixing portion 42b is designed to be slightly larger than the height of the through-hole 46 formed in a housing 41, and as the upper surface and the lower surface of the housing fixing portion 42b are respectively brought into pressure contact with the ceiling surface and the bottom surface of the through-hole 46, the housing fixing portion 42b is pressed into and fixed in the through-hole 46.

The width of the contact 42 only requires to be smaller than that of the through-hole 46 so that the contact 42 can be inserted into the through-hole 46, and the contact 42 can have a uniform width over its full length, for example.

While a contact 52 illustrated in FIG. 15 is provided with a contact portion 52a, a housing fixing portion 52b, an elastic-member attachment portion 52c and a board attachment portion 52d that are all formed of a flat plate member having a uniform thickness, as the flat plate member is bent in the housing fixing portion 52b, the housing fixing portion 52b has a press-fitting dimension in the thickness direction slightly larger than the height of a through-hole 56 formed in a housing 51. Even with such structure, the housing fixing portion 52b can be pressed into and fixed in the through-hole 56.

In addition, the contact can be formed of a pin member or a stick-like member in place of a flat plate member. A contact 52 illustrated in FIG. 16 is formed of a pin member having a circular sectional shape, and is provided with a contact portion 52a, a housing fixing portion 62b, an elastic-member attachment portion 62c and a board attachment portion 62d, that are formed. continuously at the contact 62 from its tip and to its rear end. On the other hand, the housing fixing portion 62b has a larger diameter than diameters of the contact portion 62a, the elastic-member attachment portion 62c and the board attachment portion 62d. The housing fixing portion 62b has a diameter designed to be slightly larger than the inner diameter of a through-hole 66 formed in a housing 61 so as to be pressed into and fixed in the through-hole 66.

When the contact 62 formed of a pin member of this type is used, in consideration of contacting with the contact of the counter connector, the contact portion 62a is not disposed at the bottom part of a counter-connector receiving portion 64 of the housing 61 but can be projected into the center of the counter-connector receiving portion 64.

### Embodiment 5

FIG. 17 illustrates a structure of a waterproof connector according to Embodiment 5. An elastic member 73 used in the waterproof connector has a convex portion 73a on each of the upper surface and the lower surface, whereas an elastic-member accommodation portion 75 of a housing 71 has a concave portion 75a, which corresponds to the convex portion 73a of the elastic member 73, on each of the ceiling surface and the bottom surface.

As illustrated in FIG. 18, the plurality of contacts 12 with which the elastic member 73 is integrally molded are inserted into the housing 71 through the elastic-member accommodation portion 75 and are pressed into and fixed in corresponding through-holes in the housing 71. At the same time, the elastic member 73 is accommodated in the elastic member accommodation portion 75 of the housing 71 in an elastically compressed state. In this process, as illustrated in FIG. 17, since the convex portions 73a of the elastic member 73 are respectively engaged with the concave portions 75a of the elastic-member accommodation portion 75 of the housing 71, the elastic member 73 hardly comes off the elastic-member accommodation portion 75, and the contact area between the elastic member 73 and the elastic-member accommodation portion 75 increases, thereby improving the waterproof effect.

The similar effect can be achieved even when a concave portion 83a is formed on each of the upper surface and the lower surface of an elastic member 83 while a convex portion 85a is formed on each of the ceiling surface and the bottom surface of an elastic-member accommodation portion 85 of a housing 81, and the elastic portion 83 is accommodated in the elastic-member accommodation portion 85 of the housing 81 in an elastically compressed state in such a manner that the concave portion 83a and the convex portion 85a are engaged with each other, as illustrated in FIGS. 19 and 20.

In addition, as illustrated in FIGS. 21 and 22, an elastic-member accommodation portion 95 of a housing 91 can be formed so as to be wider at the end portion than at the opening portion, an elastic member 93 can be formed to have a sectional shape corresponding to the elastic-member accommodation portion 95 of the housing 91, i.e., a sectional shape widening frontward, and the elastic member 93 can be accommodated in the elastic-member accommodation portion 95 of the housing 91 in an elastically compressed state. The elastic member 93 can be prevented from coming off the elastic-member accommodation portion 95 also in this manner.

### Other Embodiments

In Embodiment 1 described above, the contact portions 12a of the plurality of contacts 12 are respectively accommodated in the plurality of grooves 17 formed in the bottom part of the counter-connector receiving portion 14 in the housing 11. On the other hand, if each of grooves 27 used has a sectional shape that covers both edge portions of the contact portion 12a of each of the contacts 12 while allowing the center portion of a surface of the contact portion 12a to be exposed as illustrated in FIG. 23, the position of the contact portion 12a can be further stabilized, smooth engagement and reliable electrical connection with the counter connector can be achieved.

Although any of the contacts 12, 22, 32, 42 and 52 formed of a flat plate member in Embodiments 1 to 5 described above has a contact portion in a flat plate shape projecting forward, a contact portion can have a curved hook shape like a contact portion 102a of a contact 102 illustrated in FIG. 24. When the contact 102 of this type is used, the contact portion 102a has spring characteristics attributable to the hook shape, thereby improving reliability in electrical connection with the contact of the counter connector.

In this case, a through-hole 106 in a housing 101 is required to have a sectional shape with which the contact portion 102a having a hook shape can be smoothly inserted and, at the same time, a housing fixing portion 102b of the contact 102 can be pressed into the through-hole 106.

### DESCRIPTION OF SYMBOLS

1, 6 contact,
2 housing,
3 elastic sealing member,
4 through-hole,
5 contact portion,
7 elastic-sealing-member accommodation portion,
11, 41, 51, 61, 71, 81, 91, 101 housing,
11a front face,
11b rear face,
12, 22, 32, 42, 52, 62, 102 contact,
12a, 22a, 42a, 52a, 62a, 102a contact portion,
12b, 22b, 42b, 52b, 62b, 102b housing fixing portion,
12c, 22c, 32c, 42c, 52c, 62c elastic-member attachment portion,
12d, 22d, 42d, 52d, 62d board attachment portion,
13, 23, 73, 83, 93 elastic member,
14 counter-connector receiving portion,
15, 75, 83, 95 elastic-member accommodation portion,
16, 46, 56, 66, 106 through-hole,
17, 27 groove,
18 casing,
19 board,
20 opening portion,
21 gasket,
24 attachment hole,
25 slit,
73a, 85a convex portion,
75a, 83a concave portion,
D1 maximum width of housing fixing portion,
D2 width of through-hole.

1. A waterproof connector comprising:
a housing;
at least one contact held by the housing, the contact including a contact portion formed at one end of the contact to come into contact with another contact of a counter-connector, a board attachment portion formed at another end of the contact to be attached to a board, a housing fixing portion formed between the contact portion and the board attachment portion and fixed to the housing; and
an elastic-member attachment portion formed between the housing fixing portion and the board attachment portion,
wherein the housing has at least one through-hole through which the contact is inserted, and an elastic-member accommodation portion which has a concave shape and communicates with the through-hole, and
wherein the housing fixing portion of the contact is pressed into and fixed in the corresponding through-hole of the housing, and the elastic member is accommodated in the elastic-member accommodation portion of the housing.

2. The waterproof connector according to claim 1, wherein the elastic member is integrally molded with the elastic-member attachment portion of the contact.

3. The waterproof connector according to claim 1, wherein the elastic member has at least one slit for attaching the elastic member to the elastic-member attachment portion of the contact and is attached to the elastic-member attachment portion of the contact laterally through the slit that is opened.

4. The waterproof connector according to claim 1, wherein the elastic-member attachment portion of the contact has a roughened surface.

5. The waterproof connector according to claim 3, wherein the elastic member is adhered to the elastic-member attachment portion of the contact with an adhesive.

6. The waterproof connector according to claim 1, wherein the elastic-member attachment portion of the contact has a smaller cross section than cross sections of other portions of the contact adjacent to the elastic-member attachment portion.

7. The waterproof connector according to claim 1, wherein the elastic-member attachment portion of the contact has a bent portion, and the elastic member is attached to the elastic-member attachment portion so as to surround the bent portion.

8. The waterproof connector according to claim 1, wherein the elastic member is singly attached to a plurality of the contacts.

9. The waterproof connector according to claim 1, wherein the contact is formed of a flat plate member, and
wherein the housing fixing portion of the contact has a press-fitting dimension in a width direction larger than a width of the through-hole of the housing,

10. The waterproof connector according to claim 9, wherein the housing fixing portion of the contact is provided with convexity and concavity on its side surfaces in a width direction.

11. The waterproof connector according to claim 1, wherein the contact is formed of a flat plate member, and
wherein the housing fixing portion of the contact has a press-fitting dimension in a thickness direction larger than a height of the through-hole of the housing.

12. The waterproof connector according to claim 11, wherein the housing fixing portion of the contact is formed to be thicker than other portions of the contact, and the press-fitting dimension is established by a thickness of the housing fixing portion.

13. The waterproof connector according to claim 11, wherein the flat plate member having a uniform thickness is bent, thereby establishing the press-fitting dimension of the housing fixing portion of the contact.

14. The waterproof connector according to claim 1, wherein the housing has at least one groove to accommodate the contact portion of the contact.

15. The waterproof connector according to claim 14, wherein the groove has a sectional shape that covers both edge portions of the contact portion of the corresponding contact while allowing a center portion of a surface of the contact portion to be exposed.

16. The waterproof connector according to claim 1, wherein either one of the elastic-member accommodation portion of the housing and the elastic member is provided with a concave portion, whereas another one is provided with a convex portion corresponding to the concave portion, and the concave portion and the convex portion are fitted with each other.

17. The waterproof connector according to claim 1, wherein the elastic-member accommodation portion of the housing has an opening portion and an end portion formed to be wider than the opening portion, and
wherein the elastic member has a sectional shape corresponding to the elastic-member accommodation portion of the housing.
